(19) United States
(12) Patent Application Publication
(10) Pub. No.: US 2011/0025932 A1
(43) Pub. Date: Feb. 3, 2011

(54) Decoration Member and Video Display Apparatus

(76) Inventors: Kazuyuki Rikiishi, Honjo-shi (JP); Manabu Miyayama, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/903,052

(22) Filed: Oct. 12, 2010

Related U.S. Application Data
(63) Continuation of application No. 12/426,799, filed on Apr. 20, 2009.

(30) Foreign Application Priority Data
Dec. 18, 2008 (JP) 2008-322187

(51) Int. Cl. H04N 5/655

(52) U.S. Cl. 348/836; 348/E05.132

(57) ABSTRACT

A decoration member includes: a transparent member including a first surface having first and second regions and a second surface facing the first surface and having a plane surface portion corresponding to the first region and a curved surface portion corresponding to the second region; and first and second colored members disposed in the first and second regions and having colors different from each other.

### CROSS-REFERENCE TO RELATED APPLICATIONS

This application is a continuation application and claims the benefit of priority on U.S. patent application Ser. No. 12/426,799, filed Apr. 20, 2009 and is based upon and claims the benefit of priority from Japanese Patent Application No. 2008-322187, filed on Dec. 18, 2008; the entire contents of which are incorporated herein by reference.

### BACKGROUND OF THE INVENTION

1. Field of the Invention

The present invention relates to a decoration member and a video display apparatus.

2. Description of the Related Art

Conventionally, there is known a display apparatus such as a TV (television) having a plate-shaped decoration member in order to improve an appearance (for example, see JP-A 2007-25004(KOKAI)).

An appearance of a display apparatus such as a TV contributes an atmosphere of a room in which the display apparatus is set. In a conventional technology, a decoration member often has a single color, and further improvement of the appearance is desired. Further, the decoration member is sometimes constituted with a plurality of parts. When the decoration member is constituted with plural parts, there is a possibility that a manufacturing cost is increased.

### BRIEF SUMMARY OF THE INVENTION

An object of the present invention is to provide a decoration member and a video display apparatus capable of improving both an appearance and a manufacturing cost.

A decoration member according to an aspect of the present invention includes: a transparent member including a first surface having first and second regions and a second surface facing the first surface and having a plane surface portion corresponding to the first region and a curved surface portion corresponding to the second region; and first and second colored members disposed in the first and second regions and having colors different from each other.

A video display apparatus according to an aspect of the present invention includes: a video display unit; and a decoration member disposed in a periphery of the video display unit, the decoration member including a transparent member including a first surface having first and second regions and a second surface facing the first surface and having a plane surface portion corresponding to the first region and a curved surface portion corresponding to the second region and first and second colored members disposed in the first and second regions and having colors different from each other.

### BRIEF DESCRIPTION OF THE DRAWINGS

FIG. 1 is a perspective view of a decoration member 10 according to a first embodiment of the present invention.

FIG. 2 is a side view of the decoration member 10.

FIG. 3 is a schematic diagram showing an example of mounting of the decoration member 10 on a TV 9.

FIG. 4 is a side view of the TV 9.

FIG. 5 is a side view of a decoration member 20 according to a second embodiment of the present invention;

FIG. 6 is a side view of a decoration member 30 according to a third embodiment of the present invention.

FIG. 7 is a side view of a decoration member 40 according to the third embodiment of the present invention.

FIG. 8 is a side view of a decoration member 50 according to a fourth embodiment of the present invention.

FIG. 9 is an enlarged view of a boundary portion of paint layers 12 and 13.

FIG. 10 is an enlarged view of a boundary portion of paint layers 12 and 13.

### DETAILED DESCRIPTION OF THE EMBODIMENTS

### First Embodiment

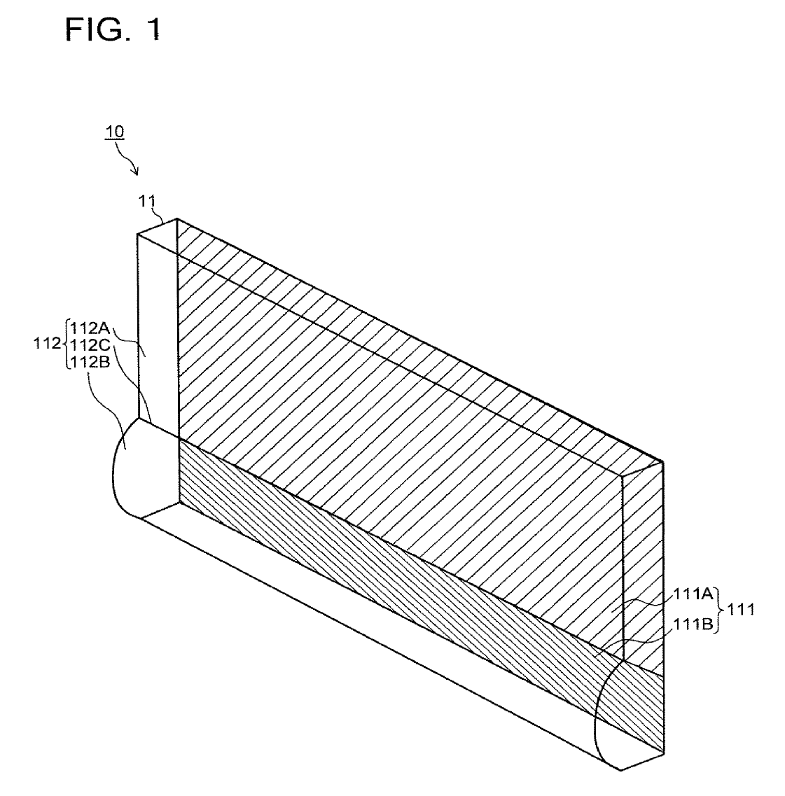

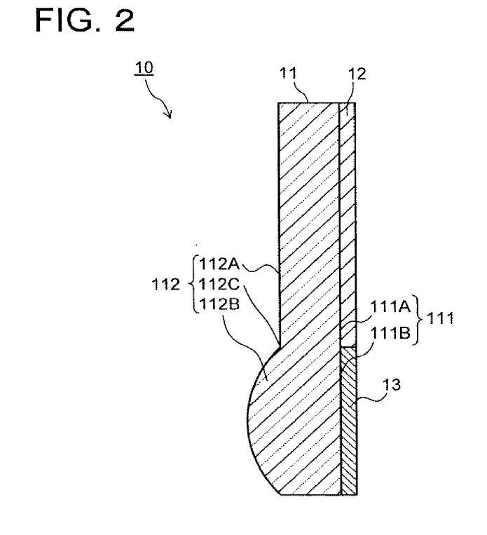

Hereinafter, a first embodiment of the present invention will be described with reference to the drawings. FIG. 1 is a perspective view of a decoration member 10 according to the first embodiment of the present invention. FIG. 2 is a side view of the decoration member 10.

As shown in FIG. 1 and FIG. 2, the decoration member 10 includes a main body 11 and paint layers 12 and 13.

The main body 11 is formed to be plate-shaped. The main body transmits light. The main body 11 is formed by extrusion-molding transparent plastic, for example, acrylic plastic or the like. A molding method of the main body is not limited in particular, and the main body 11 can be molded by means of injection molding or the like. Further, for the main body 11, a material transmitting light is preferably used in view of an appearance, and the main body 11 can be molded by processing, for example, glass or the like.

The main body 11 includes a rear surface 111 being a first surface and a front surface 112 being a second surface.

The rear surface 111 has paint regions 111A and 111B.

The paint regions 111A and 111B are first and second regions, respectively. The paint regions 111A and 111B are colored by using various techniques. For example, techniques such as painting, printing and plating are used. It should be noted that colors to be given to the paint regions 111A and 111B are not limited in particular. It should be noted that the color here includes colorlessness.

The paint region 111A is painted black, for example. The paint region 111B is painted silver, for example. By such painting, the paint layers 12 and 13 are formed in the paint regions 111A and 111B, respectively. The paint layers 12 and 13 function as first and second colored members.

The front surface 112 includes a plane surface portion 112A and a curved surface portion 112B. The plane surface portion 112A is a region having an almost rectangular shape.

The curved surface portion 112B is formed to have a semicylindrical shape. The curved surface portion 112B is provided, for example, to protrude roundedly forward from a surface of the plane surface portion 112A. The curved surface portion 112B is provided, for example, to connect both side surfaces of the front surface 112. The curved surface portion 112B is disposed under the plane surface portion 112A and includes a connection portion 112C being an edge shared with the plane surface portion 112A.

The connection portion 112C is disposed in a position corresponding to a boundary portion between the paint regions 111A and 111B. Thus, the connection portion 112 C is disposed in a position corresponding to a boundary portion between the paint layers 12 and 13.

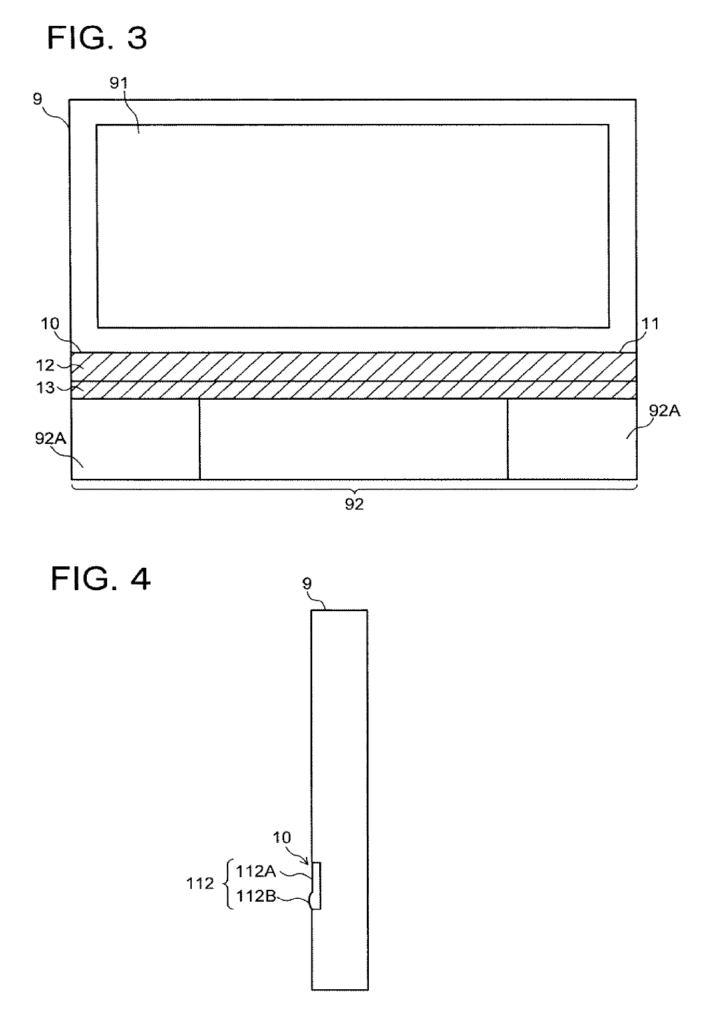

Next, a usage example of the decoration member 10 will be described by using FIG. 3 and FIG. 4. FIG. 3 is a schematic diagram showing an example of mounting of the decoration member 10 on a TV 9. FIG. 4 is a side view of the TV 9 shown in FIG. 3.

As shown in FIG. 3 and FIG. 4, the decoration member 10 can be mounted on the TV 9 being a video display apparatus. The decoration member 10 can be disposed in a periphery of a display unit 91 which the TV 9 includes. Here, as an example, the decoration member 10 is mounted between the display unit 91 and a speaker mounting portion 92 on which a speaker 92A is mounted. The decoration member 10 can be embedded in a surface of the TV 9. The decoration member 10 is mounted in a manner that the front surface 112 faces a viewer side. With regard to the decoration member 10 mounted in such a manner, since the main body 11 transmits light, a viewer can see the paint layers 12 and 13 over the main body 11.

At this time, the curved surface portion 112B functions as a lens. Consequently, the viewer feels that the paint layer 13 is disposed in a near side or in a far side of the paint layer 12.

Therefore, it appears to the viewer that the decoration member 10 is constituted with a plurality of parts of a part corresponding to the paint layer 12 and apart corresponding to the paint layer 13.

As described above, the decoration member 10 appears to be constituted with the plural parts by applying paint of colors different from each other to the rear surface 111. Therefore, an appearance of the TV 9 on which the decoration member 10 is mounted is improved. Further, since the decoration member 10 can be constituted with fewer parts compared with a case of a constitution with plural parts, a cost thereof is lower.

Further, the decoration member 10 is improved in durability compared with a case of a constitution with plural parts (for example, in a case of a constitution with two parts corresponding to an upper side and a lower side of the main body 11 divided by the connection portion 112C). In other words, if a decoration member 10 is constituted with plural parts, warpage, detachment or the like is easy to occur in a joint surface of the respective parts due to differences in durability and expansion/contraction property between the respective parts. Warpage and detachment also lead to deterioration of an appearance.

In the decoration member 10, the whole is constituted with one part (that is, the main body 11), so that warpage and detachment can be prevented.

### Second Embodiment

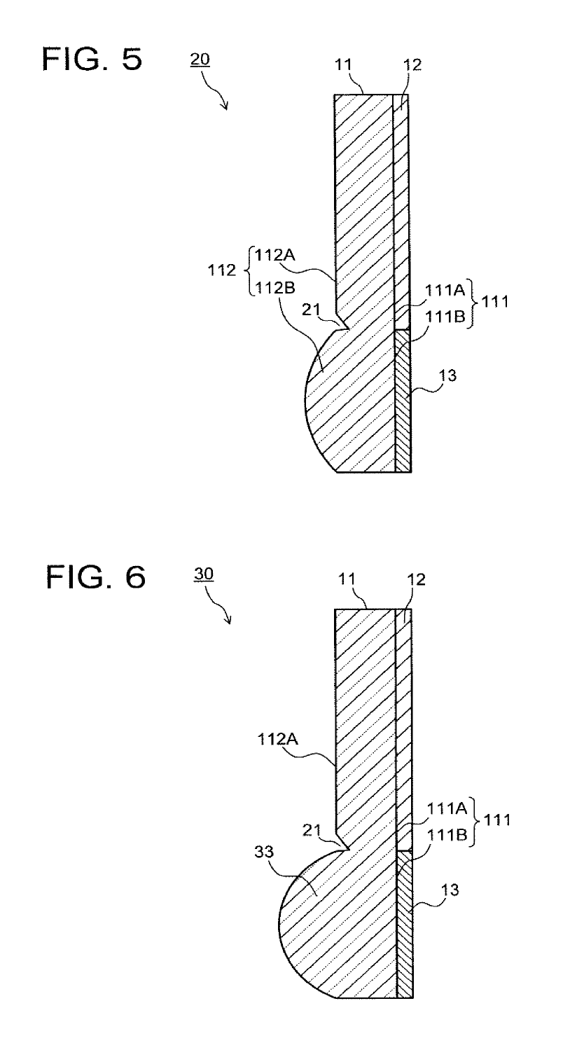

Next, a decoration member 20 according to a second embodiment will be described with reference to FIG. 5. FIG. 5 is a side view of the decoration member 20 according to the second embodiment of the present invention. It should be noted that in the following description the same portion as that in the decoration member 10 according to the first embodiment will be given the same reference numeral and symbol and detailed description will be omitted.

The decoration member 20 is made by forming a groove portion 21 in a place corresponding to the connection portion 112C which the decoration member 10 of the first embodiment includes.

In other words, as shown in FIG. 5, the decoration member 20 includes the groove portion 21. By the groove portion 21, paint layers 12 and 13 come to appear as different parts easily. Consequently, an appearance of the decoration member 20 is improved. Further, as a result that the groove portion 21 becomes a mark, forming positions of the paint layers 12 and 13 can be easier to find and forming accuracy of the paint layers 12 and 13 is improved, so that productivity or yield of the decoration member 20 is improved.

### Third Embodiment

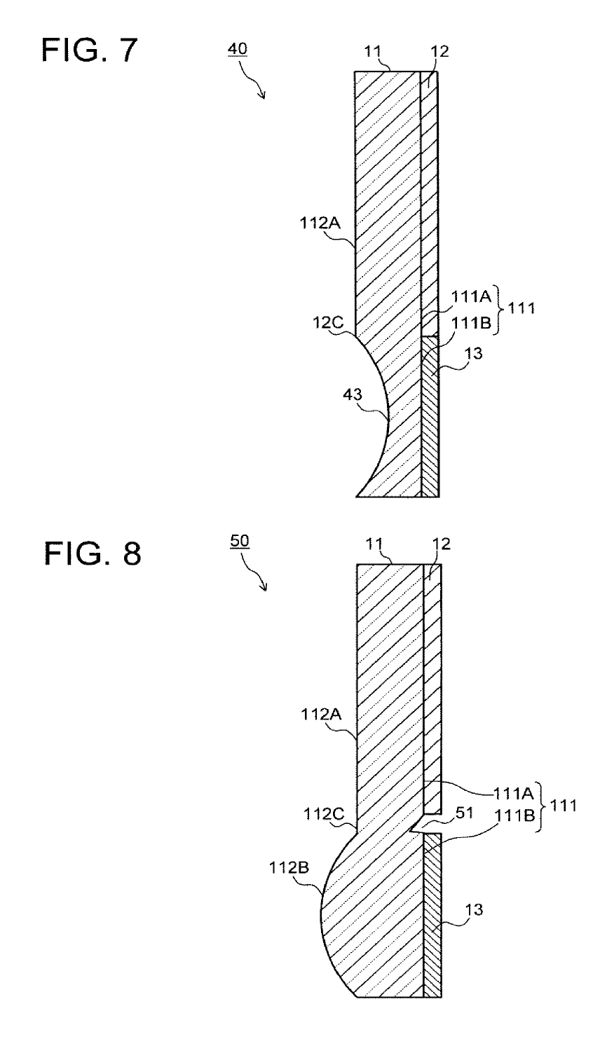

Next, decoration members 30 and 40 according to a third embodiment will be described with reference to FIG. 6 and FIG. 7. FIG. 6 and FIG. 7 are side views of the decoration members 30 and 40 according to the third embodiment of the present invention.

It should be noted that in the following description the same portion as that in the decoration member 10 or 20 according to the first or second embodiment will be given the same reference numeral and symbol and detailed description will be omitted.

The decoration members 30 and 40 are modification examples made by modifying a shape of the curved surface portion 112B which the decoration member 10 or 20 of the first or second embodiment includes.

As shown in FIG. 6, the decoration member 30 includes a curved surface portion 33. The curved surface portion 33 is formed so that a curvature thereof is larger in relation to that of the curved surface portion 112B included in the decoration member 10 or 20 of the first or second embodiment.

As a result, an effect of a lens of the curved surface portion 33 becomes stronger. In other words, paint layers 12, 13 can appear to be different parts easily.

As shown in FIG. 7, the decoration member 40 includes a curved surface portion 43. The curved surface portion 43 is provided to be recessed toward a rear surface 111 from a front surface 112. With the curved surface portion 43 constituted as above, a paint region 111A and a paint region 111B can appear to be different parts easily, similarly to with the curved surface portion 112B or the curved surface portion 33.

### Fourth Embodiment

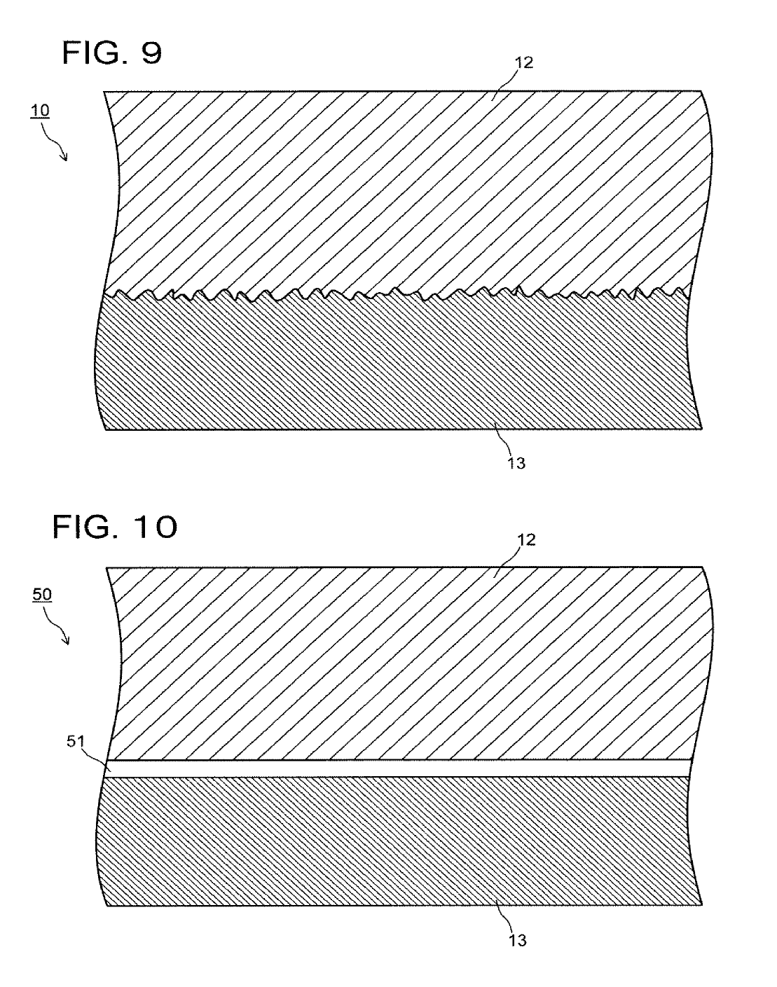

Next, a decoration member 50 according to a fourth embodiment will be described with reference to FIG. 8 to FIG. 10. FIG. 8 is a side view of the decoration member 50 according to the fourth embodiment of the present invention. FIG. 9 and FIG. 10 are enlarged views of boundary portions between paint layers 12 and 13.

It should be noted that in the following description the same portion as that in the decoration member 10 according to the first embodiment will be given the same reference numeral and symbol and detailed description will be omitted.

The decoration member 50 is made by forming a groove portion 51 being a second groove portion in the boundary portion between the paint layers 12 and 13 which the decoration member 10 of the first embodiment includes.

In other words, as shown in FIG. 8, the decoration member 50 includes the groove portion 51. The groove portion 51 is provided after paint layers 12 and 13 are formed in a main body 11, for example.

It is also possible to form the groove portion 51 first and then to form the paint layers 12 and 13. If the grove portion 51 is formed first, forming positions of the paint layers 12 and 13 become easier to find due to the groove portion 51, so that productivity or yield is improved. The groove portion 51 improves straightness of the paint layers 12 and 13.

Hereinafter, “straightness” will be explained. As shown in FIG. 9, if a groove 51 is not formed (for example, in the decoration member 10 of the first embodiment), the boundary portion between the paint layers 12 and 13 is not always straight. In other words, straightness becomes low. At this time, if the boundary portion between the paint layers 12 and 13 can be seen from the front surface 112, there is a possibility that an appearance of the TV 9 is deteriorated.

As shown in FIG. 10, if the groove portion 51 is formed, painting of the boundary portion between the paint layers 12 and 13 becomes straight. In other words, straightness is improved. At this time, even if the boundary portion between the paint layers 12 and 13 can be seen from the front surface 112, an appearance of the TV 9 is not deteriorated.

### Other Embodiments

The embodiments of the present invention are not limited to the above-describe embodiments, but can be extended or changed, and the extended and changed embodiments are also included in the technical scope of the present invention.

For example, a decoration member made by combining pieces of respective embodiments is included in the scope of the right.

In the first embodiment, the curved surface portion 112B is disposed under the front surface 112. Instead, the curved surface portion 122B can be disposed in almost center of the front surface 112. Further, a plurality of the curved surface portions 122B can be disposed in the front surface 112.

In each embodiment, the paint layers 12 and 13 are formed in the paint regions 111A and 111B. It is possible, instead of the above, not to form a paint layer 12 in a paint region 111A but to form a paint layer 13 only in a paint region 111B. In this case, a viewer can see a color of a casing of a TV 9 and a color of the paint layer 13 over a main body 11. As described above, it is possible to form a paint layer only in either one of paint regions 111A and 111B. Further, it is possible to form more paint regions than the two paint regions (111A, 111B) as in the above embodiments.

Further, it is possible to attach a plastic film called a half mirror sheet, on which aluminum is deposited, instead of a paint layer 12 or 13, in a paint region 111A or 111B.

When the half mirror sheet is attached in the paint region 111B, by providing a light emitting element (for example, an LED) or the like in a predetermined place of a TV 9, the predetermined place corresponding to the paint region 111B, it is possible to display time or a geometrical design on a curved surface potion 112B in correspondence with an ON/OFF state of the TV 9. It is also possible at this time to use an effect of a lens of the curved surface portion 112B to display time or the like in an enlarged manner. As a result, an appearance of the TV 9 is further improved.

What is claimed is:

1. A display apparatus comprising:
a display unit having a display;
a speaker unit having a speaker; and
a decoration member between the display unit and the speaker unit, the decoration member comprising
a transparent member comprising
a first surface having first and second regions and
a second surface facing the first surface at a position of the display side of the apparatus, the second surface having a plane surface portion corresponding to the first region and a curved surface portion corresponding to the second region, and
first and second colored members on the first and second regions and having colors different from each other, wherein a boundary portion between the first colored member and the second colored member corresponds to a position of the boundary portion between the plane surface portion and the curved surface portion.

2. The display apparatus according to claim 1,
wherein the plane surface portion has an almost rectangular shape, and
wherein the curved surface portion shares an edge with the plane surface portion.

3. The display apparatus according to claim 1, further comprising a groove portion provided in the boundary portion between the plane surface portion and the curved surface portion.

4. The display apparatus according to claim 1, further comprising a groove portion provided in a boundary portion between the first and second regions.

5. The display apparatus according to claim 1, wherein the decoration member is disposed in a periphery of the display unit.

6. A display apparatus comprising:
a display unit including a display;
a speaker unit including a speaker; and
a decoration member situated between the display unit and the speaker unit, the decoration member comprising
a transparent main body comprising a (i) a substantially planar surface portion and (ii) a curved surface portion,
a layer situated behind the transparent main body, the layer comprises (i) a first region having a first color and positioned to correspond to the substantially planar surface portion and (ii) a second region having a second color different from the first color and positioned to correspond to the curved surface portion, and
a boundary portion corresponding in position between the substantially planar surface portion and the curved surface portion and between the first region and the second region.

7. The display apparatus according to claim 6, wherein the substantially planar surface portion comprises a plurality of edges substantially forming a rectangle in shape with one of the plurality of edges being shared with the curved surface portion.

8. The display apparatus according to claim 6, further comprising a groove portion formed in the boundary portion between the substantially planar surface portion and the curved surface portion of the transparent main body.

9. The display apparatus according to claim 6, further comprising a groove portion formed in the boundary portion between the first region of the layer and the second region of the layer.

10. The display apparatus according to claim 6, wherein the decoration member is disposed in a periphery of the display unit.

11. A display apparatus comprising:
a display;
a speaker unit; and
a decoration member situated between the display and the speaker unit, the decoration member comprising
a transparent main body that comprises a front surface and a back surface, the front surface comprises (i) a substantially planar surface portion and (ii) a curved surface portion,
a layer situated behind the back surface of the transparent main body, the layer comprises (i) a first region positioned to correspond with the substantially planar surface portion and (ii) a second region having a color different from a color of the first region and the second region being positioned to correspond with the curved surface portion, and
a boundary portion position between the substantially planar surface portion and the curved surface portion.

12. The display apparatus according to claim 11, wherein the boundary portion of the decoration member is further positioned between the first region of the layer and the second region of the layer.

13. The display apparatus according to claim 11, wherein a light emitting diode (LED) unit is positioned in the second region of the layer and visible through the curved surface portion of the transparent main body.

14. The display apparatus according to claim 11, wherein first region is painted a first color and the second region is painted a second color differing from the first color.

15. The display apparatus according to claim 11, wherein second region is painted a first color so that the second region has a color different from the color of the first region.

16. The display apparatus according to claim 11, wherein the substantially planar surface portion of the transparent main body of the decoration member comprises a plurality of edges substantially forming a rectangle in shape with one of the plurality of edges being shared with the curved surface portion of the transparent main body.

17. The display apparatus according to claim 11, further comprising a groove portion formed in the boundary portion between the substantially planar surface portion of the transparent main body and the curved surface portion of the transparent main body.

18. The display apparatus according to claim 11, further comprising a groove portion formed in the boundary portion between the first region of the layer and the second region of the layer.

19. The display apparatus according to claim 11, wherein the decoration member is oriented to be positioned vertically above the speaker unit.

20. The display apparatus according to claim 11 being a television.
